(19) United States
(12) Patent Application Publication
(10) Pub. No.: US 2024/0334455 A1
(43) Pub. Date: Oct. 3, 2024

(54) COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Shichang ZHANG, Dongguan (CN); Huei-Ming LIN, Taipei (CN); Zhenshan ZHAO, Dongguan (CN); Teng MA, Dongguan (CN)

(21) Appl. No.: 18/733,411

(22) Filed: Jun. 4, 2024

Related U.S. Application Data
(63) Continuation of application No. PCT/CN2021/142488, filed on Dec. 29, 2021.

(51) Int. Cl. H04W 72/25; H04L 5/00; H04W 64/00

(52) U.S. Cl. CPC H04W 72/25; H04L 5/0048; H04W 64/006

(57) ABSTRACT

This application provides a communication method and a terminal device. The communication method includes: A terminal device transmits or receives a first positioning reference signal PRS and first control information on a sidelink, where the first control information indicates the first PRS.

### CROSS-REFERENCE TO RELATED APPLICATIONS

This application is a continuation of International Application No. PCT/CN2021/142488, filed on Dec. 29, 2021, the disclosure of which is hereby incorporated by reference in its entirety.

### TECHNICAL FIELD

This application relates to the field of communications technologies, and more specifically, to a communication method and a terminal device.

### BACKGROUND

Sidelink communication may be performed between terminal devices through a sidelink (SL). A sidelink-based positioning method is not proposed in a related technology, which fails to support a sidelink-based positioning use case, and thus a sidelink-based positioning requirement cannot be met.

### SUMMARY

This application provides a communication method and a terminal device, to support sidelink-based positioning.

According to a first aspect, a communication method is provided. The communication method includes: A terminal device transmits or receives a first positioning reference signal PRS and first control information on a sidelink, where the first control information indicates the first PRS.

According to a second aspect, a terminal device is provided. The terminal device includes a first transmission unit, configured to transmit or receive a first positioning reference signal PRS and first control information on a sidelink, where the first control information indicates the first PRS.

According to a third aspect, a terminal device is provided, including a processor, a memory, and a communications interface. The memory is configured to store one or more computer programs, and the processor is configured to invoke the computer program in the memory to cause the terminal device to execute the method according to the first aspect.

According to a fourth aspect, an embodiment of this application provides a communications system, where the system includes the foregoing terminal device. In another possible design, the system may further include another device that interacts with the terminal device in the solution provided in embodiments of this application.

According to a fifth aspect, an embodiment of this application provides a computer-readable storage medium, where the computer-readable storage medium stores a computer program, and the computer program causes a terminal device to execute some or all of the steps in the method according to the first aspect.

According to a sixth aspect, an embodiment of this application provides a computer program product, where the computer program product includes a non-transitory computer-readable storage medium that stores a computer program, and the computer program is operable to cause a terminal to execute some or all of the steps of the method according to the first aspect. In some implementations, the computer program product may be a software installation package.

According to a seventh aspect, an embodiment of this application provides a chip, where the chip includes a memory and a processor, and the processor may invoke a computer program from the memory and run the computer program, to implement some or all of the steps described in the method according to the first aspect.

According to an eighth aspect, a computer program product is provided, including a program, where the program causes a computer to execute the method according to the first aspect.

According to a ninth aspect, a computer program is provided, where the computer program causes a computer to execute the method according to the first aspect.

A terminal device may transmit or receive a first PRS based on an indication of first control information, and the terminal device may implement sidelink-based positioning based on the first PRS. Therefore, according to the method provided in this application, a sidelink-based positioning use case may be supported, and a sidelink-based positioning requirement is met.

### BRIEF DESCRIPTION OF DRAWINGS

FIG. 1 is an example diagram of a system architecture of a wireless communications system to which embodiments of this application are applicable.

FIG. 2 is an example diagram of a scenario of sidelink communication within network coverage.

FIG. 3 is an example diagram of a scenario of sidelink communication with partial network coverage.

FIG. 4 is an example diagram of a scenario of sidelink communication out of network coverage.

FIG. 5 is an example diagram of a broadcast-based sidelink communication manner.

FIG. 6 is an example diagram of a unicast-based sidelink communication manner.

FIG. 7 is an example diagram of a multicast-based sidelink communication manner.

FIG. 8 is an example diagram of a slot used for sidelink communication.

FIG. 9 is an example diagram of another slot used for sidelink communication.

FIG. 10 is an example diagram of still another slot used for sidelink communication.

FIG. 11 is an example diagram of a PSSCH DMRS frequency domain position.

FIG. 12 is a schematic flowchart of a communication method according to an embodiment of this application.

FIG. 13 is a schematic diagram of a division manner of a first slot according to an embodiment of this application.

FIG. 14 is a schematic diagram of a resource division manner according to an embodiment of this application.

FIG. 15 is a schematic diagram of another resource division manner according to an embodiment of this application.

FIG. 16 is a schematic diagram of still another resource division manner according to an embodiment of this application.

FIG. 17 is a schematic diagram of yet another resource division manner according to an embodiment of this application.

FIG. 18 is a schematic diagram of a structure of a terminal device according to an embodiment of this application.

FIG. 19 is a schematic diagram of a structure of another terminal device according to an embodiment of this application.

### DESCRIPTION OF EMBODIMENTS

The following describes the technical solutions in this application with reference to the accompanying drawings.

### Communications System

FIG. 1 shows a wireless communications system 100 to which an embodiment of this application is applied. The wireless communications system 100 may include a network device 110 and a terminal device 120. The network device 110 may be a device that communicates with the terminal device 120. The network device 110 may provide communication coverage for a specific geographic area, and may communicate with the terminal device 120 located within the coverage.

Optionally, the wireless communications system 100 may include a plurality of network devices, and another quantity of terminal devices may be included within coverage of each network device, which is not limited in embodiments of this application.

Optionally, the wireless communications system 100 may further include other network entities such as a network controller and a mobility management entity, which is not limited in embodiments of this application.

It should be understood that technical solutions of embodiments of this application may be applied to various communications systems, such as a 5th generation (5G) system or a new radio (NR) system, a long term evolution (LTE) system, an LTE frequency division duplex (FDD) system, and LTE time division duplex (TDD). The technical solutions provided in this application may further be applied to a future communications system, such as a 6^{th} generation mobile communications system or a satellite communications system.

The terminal device in embodiments of this application may also be referred to as user equipment (UE), an access terminal, a user unit, a user station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or the like. Optionally, the terminal device may be used to act as a base station. For example, the terminal device may act as a scheduling entity that provides a sidelink signal between terminal devices in vehicle-to-everything (V2X), device-to-device (D2D) communications, or the like. For example, a cellular phone and a vehicle communicate with each other by using a sidelink signal. A cellular phone and a smart home device communicate with each other, without relaying a communication signal by using a base station. Optionally, the terminal device may be used to act as a base station.

The network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names in the following, or may be interchangeable with one of the following names, for example, a NodeB, an evolved NodeB (eNB), a next generation NodeB (gNB), a relay station, an access point, a transmitting and receiving point (TRP), a transmitting point (TP), a master MeNB, a secondary SeNB, a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device-to-device (D2D), vehicle-to-vehicle (V2V), vehicle-to-everything (V2X), and machine-to-machine (M2M) communications, a network-side device in a 6G network, a device that functions as a base station in a future communications system, or the like. The base station may support networks of the same or different access technologies. A specific technology and a specific device form that are used by the network device are not limited in embodiments of this application.

The base station may be fixed or mobile. For example, a helicopter or an unmanned aerial vehicle may be configured to act as a mobile base station, and one or more cells may move depending on a position of the mobile base station. In other examples, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being deployed indoors or outdoors, handheld, or vehicle-mounted, may be deployed on a water surface, or may be deployed on a plane, a balloon, or a satellite in the air. Scenarios in which the network device and the terminal device are located are not limited in embodiments of this application.

It should be understood that all or some of functions of the communications device in this application may also be implemented by software functions running on hardware, or by virtualization functions instantiated on a platform (for example, a cloud platform).

### Sidelink Communication in Different Network Coverage Statuses

Sidelink communication means a sidelink-based communications technology. Sidelink communication may be, for example, D2D or V2X. Sidelink communication supports direct transmission of communication data between a terminal device and a terminal device. Direct transmission of the communication data between the terminal device and the terminal device may have higher spectral efficiency and a lower transmission delay. For example, an internet of vehicles system uses a sidelink communications technology.

Sidelink communication may be divided, depending on a network coverage status of the terminal device, into sidelink communication within network coverage, sidelink communication with partial network coverage, and sidelink communication out of network coverage.

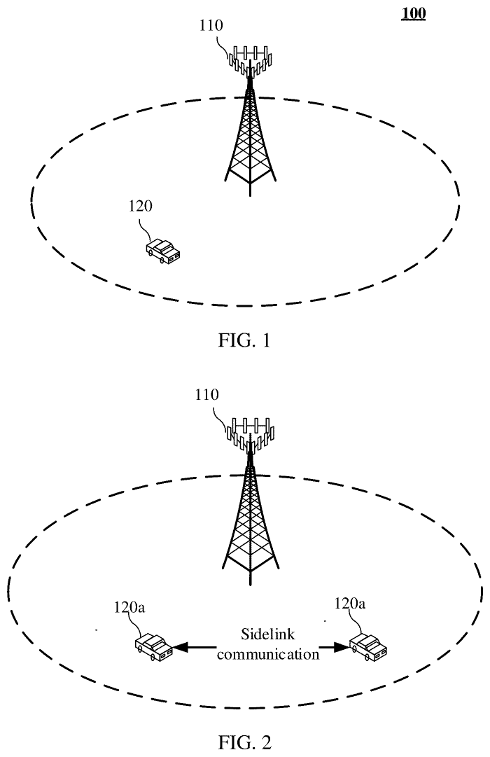

FIG. 2 is an example diagram of a scenario of sidelink communication within network coverage. In the scenario shown in FIG. 2, two terminal devices 120a are all located within coverage of a network device 110. Therefore, both the two terminal devices 120a may receive configuration signalling (where the configuration signalling in this application may alternatively be replaced with configuration information) of the network device 110, and determine a sidelink configuration based on the configuration signalling of the network device 110. After both the two terminal devices 120a perform sidelink configuration, sidelink communication may be performed on a sidelink.

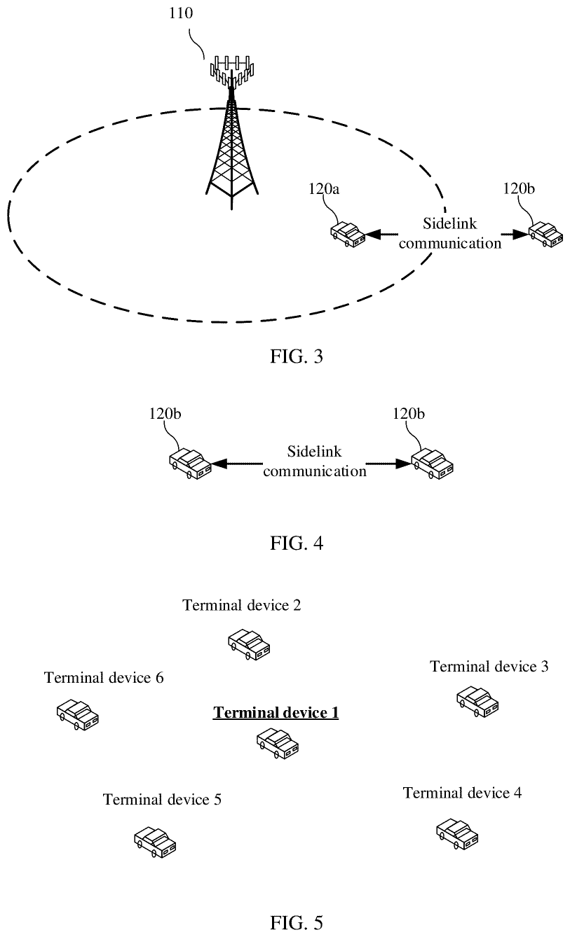

FIG. 3 is an example diagram of a scenario of sidelink communication with partial network coverage. In the scenario shown in FIG. 3, a terminal device 120a performs sidelink communication with a terminal device 120b. The terminal device 120a is located within coverage of a network device 110. Therefore, the terminal device 120a can receive configuration signalling of the network device 110, and determine a sidelink configuration based on the configuration signalling of the network device 110. The terminal device 120b is located out of network coverage, and cannot receive the configuration signalling of the network device 110. In this case, the terminal device 120b may determine a sidelink configuration based on pre-configuration information and/or information that is carried on a physical sidelink broadcast channel (PSBCH) and that is sent by the terminal device 120a located within the network coverage. After both the terminal device 120a and the terminal device 120b perform sidelink configuration, sidelink communication may be performed on a sidelink.

FIG. 4 is an example diagram of a scenario of sidelink communication out of network coverage. In the scenario shown in FIG. 4, two terminal devices 120b are all located out of network coverage. In this case, both the two terminal devices 120b may determine a sidelink configuration based on pre-configuration information. After both the two terminal devices 120b perform sidelink configuration, sidelink communication may be performed on a sidelink.

### Mode of Sidelink Communication

Two modes (or referred to as transmission modes) of sidelink communication are defined in some standards or protocols (for example, 3rd Generation Partnership Project (3GPP)): a first mode and a second mode.

In the first mode, a resource (the resource mentioned in this application may also be referred to as a transmission resource, such as a time frequency resource) of a terminal device is allocated by a network device. The terminal device may send data on a sidelink based on the resource allocated by the network device. The network device may allocate a resource for a single time of transmission to the terminal device, or may allocate a resource for semi-static transmission to the terminal device. The first mode may be applied to a scenario in which there is coverage of the network device, for example, the scenario shown in FIG. 2 above. In the scenario shown in FIG. 2, the terminal device 120a is located within the network coverage of the network device 110. Therefore, the network device 110 may allocate, to the terminal device 120a, a resource used in a sidelink transmission process.

In the second mode, the terminal device may independently select one or more resources from a resource pool (RP). Then, the terminal device may perform sidelink transmission based on the selected resource. For example, in the scenario shown in FIG. 4, the terminal device 120b is located out of the cell coverage. Therefore, the terminal device 120b may independently select a resource from a pre-configured resource pool to perform sidelink transmission. Alternatively, in the scenario shown in FIG. 2, the terminal device 120a may independently select one or more resources from a resource pool configured by the network device 110 to perform sidelink transmission.

In the second mode, selecting the resource used for sidelink communication may include step S110 and step S120.

Step S110: The terminal device uses all available resources in a resource selection window as a resource set A. The terminal device may exclude resources in the resource set A, and use remaining resources after exclusion as a candidate resource set.

In an implementation, if the terminal device sends data in some slots in a listening window and does not perform listening, all resources in slots corresponding to the slots in the selection window may be excluded. The terminal device may use a value set of a resource reservation period field in a used resource pool configuration to determine a corresponding slot in the selection window.

In another implementation, the terminal device may determine, based on a measured reference signal received power (RSPR), the resources excluded from the resource set A. For example, if the terminal device listens to a physical sidelink control channel (PSCCH) in the listening window, the terminal device may measure an RSRP of the PSCCH and/or an RSRP of a PSSCH scheduled by the PSCCH. If the measured RSRP is greater than a sidelink reference signal received power (SL-RSRP) threshold, and it is determined, based on resource reservation information in sidelink control information being performed transmission on the PSCCH, that a reserved resource thereof is in the resource selection window, the terminal device may exclude a corresponding resource from the set A. If the remaining resources in the resource set A are less than or equal to X % of all the resources before resource exclusion is performed on the resource set A, the SL-RSRP threshold may be increased by 3 dB, and the terminal device executes step S110 again. X may be any one in a value set, and the value set may be, for example, {20, 35, 50}. The terminal device may determine the parameter X from the value set based on a priority of to-be-sent data. It should be noted that the SL-RSRP threshold may be related to a priority carried in the PSCCH that the terminal device listens to. The SL-RSRP threshold may also be related to the priority of the to-be-sent data of the terminal device.

Step S120: The terminal device may select several resources from the candidate resource set, where these resources may be used as transmit resources for performing initial transmission and/or retransmission of sidelink communication.

### Data Transmission Modes of Sidelink Communication

Some sidelink communications systems (for example, LTE-V2X) support a broadcast-based data transmission mode (referred to as broadcast transmission for short). For the broadcast transmission, a receive end terminal device may be any terminal device around a transmit end terminal device. For example, in FIG. 5, a terminal device 1 is a transmit end terminal device, and a receive end terminal device corresponding to the transmit end terminal device is any terminal device around the terminal device 1, for example, may be a terminal device 2 to a terminal device 6 in FIG. 5.

In addition to the broadcast transmission, some communications systems also support a unicast-based data transmission mode (referred to as unicast transmission for short) and/or a multicast-based data transmission mode (referred to as multicast transmission for short). For example, NR-V2X expects to support autonomous driving. Autonomous driving poses higher requirements for data interaction between vehicles. For example, data interaction between vehicles requires a higher throughput, a lower delay, higher reliability, larger coverage, a more flexible resource allocation manner, and the like. Therefore, to improve performance of data interaction between vehicles, NR-V2X introduces unicast transmission and multicast transmission.

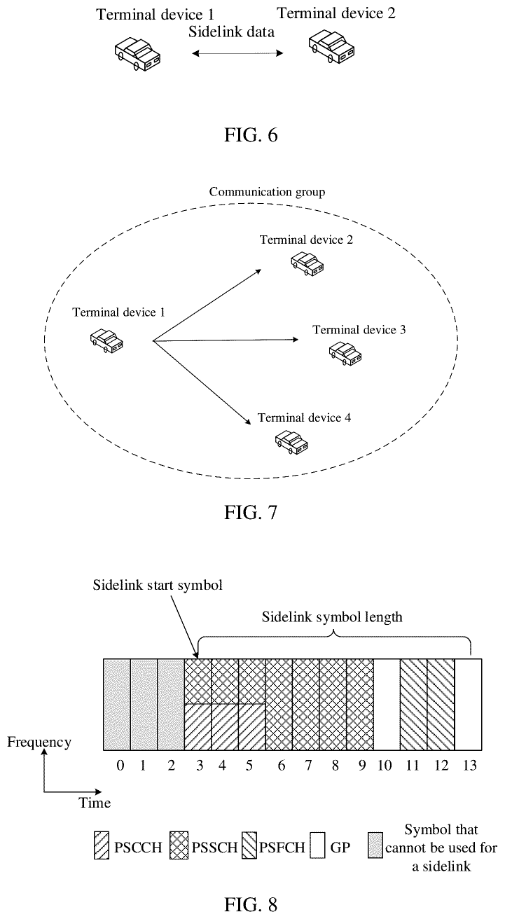

For the unicast transmission, the receive end terminal device usually has only one terminal device. For example, in FIG. 6, unicast transmission is performed between a terminal device 1 and a terminal device 2. The terminal device 1 may be a transmit end terminal device, and the terminal device 2 may be a receive end terminal device. Alternatively, the terminal device 1 may be a receive end terminal device, and the terminal device 2 may be a transmit end terminal device.

For the multicast transmission, the receive end terminal device may be a terminal device in a communication group, or the receive end terminal device may be a terminal device within a specific transmission distance. For example, in FIG. 7, a terminal device 1, a terminal device 2, a terminal device 3, and a terminal device 4 constitute a communication group. If the terminal device 1 sends data, all the other terminal devices (the terminal device 2 to the terminal device 4) in the group may be receive end terminal devices.

### Resource Allocation of Sidelink Communication

In some communications systems (for example, NR-V2X), time domain resources may be allocated at a slot granularity. A start point and a length of a time domain symbol (which may be referred to as a symbol for short) used for sidelink transmission in one slot may be respectively configured based on a parameter sidelink start symbol (sl-startSLsymbols) and a sidelink symbol length (sl-lengthSLsymbols). The time domain symbol may be, for example, an orthogonal frequency division multiplexing (OFDM) symbol. A physical sidelink shared channel (PSSCH) may be transmitted in the same slot as a PSCCH associated with the PSSCH. The PSCCH may occupy two or three time domain symbols. The last symbol in one slot may be used as a guard period (GP). The PSSCH and the PSCCH may use remaining time domain symbols other than the GP. In some embodiments, a slot used for sidelink communication may also be referred to as a sidelink slot.

It should be noted that a resource used for physical sidelink feedback channel (PSFCH) transmission may further exist in one slot. If a PSFCH transmission resource is configured in one slot, the PSSCH and the PSCCH cannot occupy a time domain symbol used for PSFCH transmission, and automatic gain control (AGC) and GP symbols before the symbol.

FIG. 8 is an example diagram of a slot used for sidelink communication. It can be learned from FIG. 8 that, in sl-StartSymbol=3 and sl-LengthSymbols=11 that are configured by a network device, 11 time domain symbols that start from a symbol index 3 in one slot may be used for sidelink transmission. In the slot shown in FIG. 8, there is a transmission resource of a PSFCH, and the transmission resource of the PSFCH occupies a symbol 11 and a symbol 12. The symbol 11 may be used as an AGC symbol of the PSFCH. A symbol 10 and a symbol 13 may be separately used as a GP. A symbol 3 to a symbol 9 may be time domain symbols for PSSCH transmission. Time domain symbols used for PSCCH transmission may occupy three symbols: the symbols 3, 4, and 5. The symbol 3 may be used as an AGC symbol.

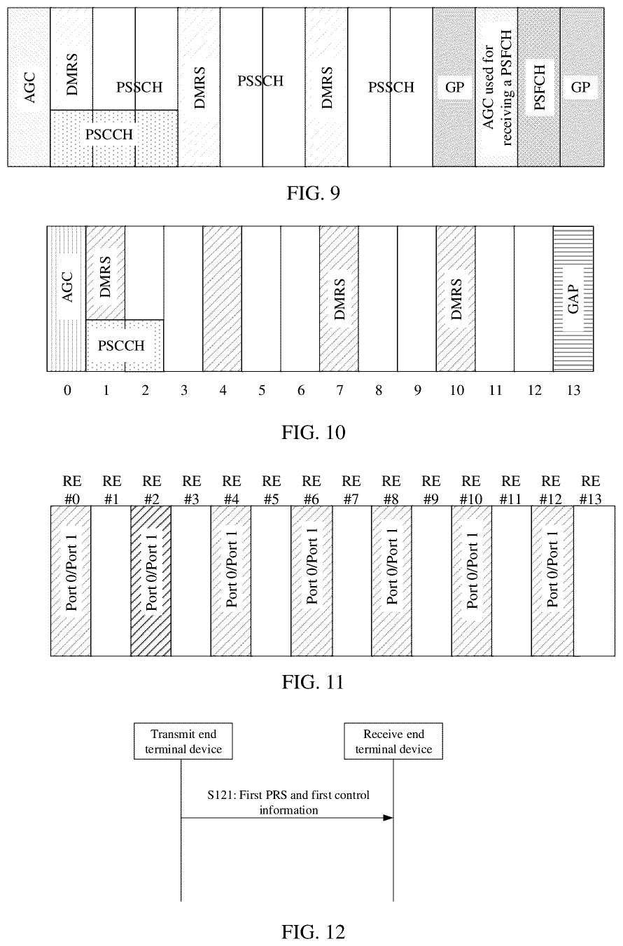

FIG. 9 is an example diagram of another slot used for sidelink communication. In the slot shown in FIG. 9, the 1^{st} symbol may be fixed for AGC. On an AGC symbol, a terminal device may copy information sent on the 2^{nd} symbol. At the end of the slot, one symbol may be reserved for transmitting/receiving conversion. That is, the terminal device may implement conversion between a transmit state and a receive state by using the symbol. In remaining symbols, a PSCCH may occupy two or three symbols that start from the 2^{nd} sidelink symbol. In frequency domain, a quantity of physical resource blocks (PRBs) occupied by the PSCCH falls within a subband range of one PSSCH. If a quantity of PRBs occupied by the PSCCH is less than that occupied by one subchannel of the PSSCH, or a frequency domain resource of the PSSCH includes a plurality of subchannels, on a symbol in which the PSCCH is located, the PSCCH may be frequency-division-multiplexed with the PSSCH.

A demodulation reference signal (DMRS) may be used for data demodulation. In one resource pool, a quantity of available DMRS patterns is related to a quantity of PSSCH symbols in the resource pool. For specific quantities of PSSCH symbols (including the 1^{st} AGC symbol) and PSCCH symbols, an available DMRS pattern and a position of each DMRS symbol in the pattern may be shown in Table 1.

TABLE 1

| Quantity of | Position of a DMRS symbol (relative to a position of the 1^{st} AGC symbol) | | | | | |
|---|---|---|---|---|---|---|
| PSSCH symbols | Quantity of PSCCH symbols being 2 | | | Quantity of PSCCH symbols being 3 | | |
| (including the | Quantity of DMRS symbols | | | Quantity of DMRS symbols | | |
| 1^{st} AGC symbol) | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

FIG. 10 shows an example of time domain positions of four DMRS symbols when a PSSCH occupies 13 symbols. As shown in FIG. 10, the four DMRS symbols may be symbols 1, 4, 7, and 10.

If a plurality of time domain DMRS patterns are configured in a resource pool used for sidelink communication, a specifically used time domain DMRS pattern may be selected by a terminal device that sends data. The terminal device may indicate the used time domain DMRS pattern in first-order sidelink control information (SCI). In a case in which the terminal device moves at a high speed, the terminal device may select a high-density DMRS pattern, thereby ensuring accuracy of channel estimation. In a case in which the terminal device moves at a low speed, the terminal device may use a low-density DMRS pattern, thereby improving spectrum efficiency.

A generation manner of a PSSCH DMRS sequence is similar to a generation manner of a PSCCH DMRS sequence. An initialization formula cᵢₙᵢₜ of a pseudo-random sequence c (m) of the PSSCH DMRS sequence may include N_{ID}, and N_{ID} may satisfy N_{ID}=Σᵢ₌₀^{L-1}pᵢ·2^{L-1-i}·pᵢ may be an i^{th}-bit cyclic redundancy check (cyclic redundancy check, CRC) of a PSCCH that schedules the PSSCH, L may be a quantity of PSCCH CRC bits, and a value of L may be L=24.

In some communications systems (for example, an NR system), a PDSCH and a PUSCH may support two frequency domain DMRS patterns: a DMRS frequency domain type 1 and a DMRS frequency domain type 2. For each frequency domain type, there may be two different types: a single-symbol DMRS frequency domain type and a double-symbol DMRS frequency domain type. A single-symbol DMRS frequency domain type 1 may support four DMRS ports, and a single-symbol DMRS frequency domain type 2 may support six DMRS ports. In a case of the double-symbol DMRS frequency domain type, a quantity of supported ports is doubled. In some sidelink communications systems (for example, NR-V2X), because a PSSCH only needs to support a maximum of two DMRS ports, only a single-symbol DMRS frequency domain type 1 is supported. FIG. 11 is an example diagram of a PSSCH DMRS frequency domain position in a case of a single-symbol DMRS frequency domain type 1.

### Sidelink-Based Positioning

With development of technologies, a related technology provides a sidelink-based positioning use case. For example, in 3GPP R-17, 3GPP RAN studies “NR positioning enhancements” and “scenarios and requirements of in-coverage, partial coverage, and out-of-coverage NR positioning use cases”. The study on “scenarios and requirements of in-coverage, partial coverage, and out-of-coverage NR positioning use cases” focuses on V2X and public safety use cases, and a study result is recorded in TR38.845. In addition, SAI formulates a “ranging-based services” requirement in TS22.261, and formulates a positioning accuracy requirement in TS22.104 for use of an industrial internet of things (IoT) in an out-of-coverage scenario.

A sidelink-based positioning method is not proposed in the related technology. As a result, a sidelink-based positioning use case cannot be supported, and a sidelink-based positioning requirement cannot be met.

To resolve the foregoing problem, this application provides a communication method. FIG. 12 is a schematic flowchart of a communication method according to an embodiment of this application. The method shown in FIG. 12 may be executed by a terminal device. The terminal device may be a receive end terminal device or a transmit end terminal device. The method shown in FIG. 12 may include step S121.

Step S121: The terminal device transmits or receives a first PRS and first control information on a sidelink. For example, the terminal device is a transmit end terminal device, and the terminal device may send the first PRS and the first control information to a receive end terminal device. Alternatively, for example, the terminal device is a receive end terminal device, and the terminal device may receive the first PRS and the first control information sent by a transmit end terminal device.

The first PRS may be used for determining positioning information about the terminal device. For example, the terminal device may determine absolute positioning and/or relative positioning of the terminal device based on the received first PRS. The absolute positioning may include a global positioning coordinate of the terminal device. The relative positioning may include a distance and/or a direction of the terminal device relative to a first device that performs sidelink communication with the terminal device.

Related information about the first PRS may be uncertain (for example, not a preset value). For example, at least one piece of the following information may be uncertain: a sending position of the first PRS, a quantity of sending times, a sequence used by the first PRS, and the like. This application provides a first control information, to indicate the first PRS.

In an implementation, the first control information may include one or more pieces of the following information: an identity of the first PRS, a position of a resource occupied by the first PRS, a quantity of repetition times of the first PRS, a sending periodicity of the first PRS, and information about a terminal device that sends the first PRS.

The identity of the first PRS may include identity (ID) information about the first PRS. The position of the resource occupied by the first PRS may include a time domain resource position and/or a frequency domain resource position occupied by the first PRS. The information about the terminal device that sends the first PRS may include a geographic position of the terminal device, a type of the terminal device, and/or the like.

It may be understood that specific or some information related to the first PRS may be indicated by the first control information, or may be predefined. For example, a position and a quantity of DM symbols occupied by the first PRS and/or a resource element (RE) occupied by the first PRS on each OFDM symbol may be predefined.

The terminal device may transmit or receive the first PRS based on an indication of the first control information, and the terminal device may implement sidelink-based positioning based on the first PRS. Therefore, according to the method provided in this application, a sidelink-based positioning use case may be supported, and a sidelink-based positioning requirement is met.

A transmission resource of the first PRS may be a first resource, and a transmission resource of the first control information may be a second resource. This application does not limit a resource pool to which the first resource or the second resource belongs. The resource pool may include a first resource pool and/or a second resource pool. The first resource pool may be used for sidelink communication. The second resource pool may be different from the first resource pool. For example, the second resource pool and the first resource pool may be configured by using different signalling. It may be understood that the second resource pool may be a PRS-dedicated resource pool. That is, the terminal device that sends the first PRS may assume that a sidelink channel or a signal sent by a terminal device does not exist in the second resource pool.

With reference to the following embodiments, the following describes in detail the first resource of the first PRS and the second resource of the first control information.

### Embodiment 1: Both the First Resource and the Second Resource Belong to the First Resource Pool

In an implementation, the first resource pool may include a third resource. The first resource used for transmission of the first PRS may be located in a time frequency range of the third resource. The third resource may include a resource occupied by a PSSCH and/or a resource occupied by a DMRS of the PSSCH. In other words, the first PRS may be sent together with the PSSCH used for sidelink communication. A transmit resource of the first PRS may be located in a time frequency range occupied by the PSSCH and/or by the DMRS of the PSSCH.

Optionally, the time frequency range of the resource occupied by the PSSCH and/or the time frequency range of the resource occupied by the DMRS of the PSSCH may be determined according to the foregoing rule or a rule of a related technology (for example, a 3GPP Rel-16 standard).

In another implementation, the first resource pool may include a fourth resource. The first resource used for transmission of the first PRS may be located on a symbol in which the fourth resource is located. The fourth resource may include a resource occupied by a PSFCH. For example, the first resource may be located on an OFDM symbol in which the PSFCH resource is located. It may be understood that there may be a channel and/or a signal used for sidelink communication in the first resource pool.

A channel that carries the first control information may include a PSSCH and/or a PSCCH. A structure of the PSSCH and/or the PSCCH carrying the first control information may be the same as or different from a structure defined in a related technology.

In an implementation, the first control information may be indicated by sidelink control information for scheduling the PSSCH. It may be understood that the sidelink control information may indicate only the first control information, may indicate only sidelink communication, or may indicate both the first control information and sidelink communication. For example, the first control information is indicated by the sidelink control information, and the first control information may be included in first-order SCI and/or second-order SCI. For example, redundant bits in the PSCCH used for carrying the sidelink control information may indicate whether there is the first PRS in a PSSCH scheduled by the PSCCH. Alternatively, a new second-order SCI format may be defined, to indicate whether there is the first PRS and/or a sending manner of the first PRS in the scheduled PSSCH. The sending manner of the first PRS may include one or more pieces of the following information: a time frequency resource position occupied by the first PRS, a quantity of repetition times of the first PRS, a sequence of the first PRS, and the like.

Optionally, an identity of the first PRS may be determined by a CRC of a PSCCH that schedules a PSSCH. For example, the ID of the first PRS may be determined by N_{ID}^{X}, and N_{ID}^{X} may satisfy N_{ID}^{X}=Σᵢ₌₀^{L-1}pᵢ·2^{L-1-i}, where pᵢ may be an i^{th}-bit CRC of the PSCCH that schedules the PSSCH, L may be a quantity of PSCCH CRC bits, and a value of L may be L=24.

### Embodiment 2: Both the First Resource and the Second Resource Belong to the Second Resource Pool

### Embodiment 2.1

Both the first resource and the second resource belong to the second resource pool. The second resource may be not later than the first resource. In other words, the first control information may be sent not later than the first PRS. For example, a slot in which the second resource is located may be earlier than a slot in which the first resource is located. Alternatively, the first resource and the second resource may be located in a same slot.

In an implementation, in the second resource pool, the 1^{st} slot in every P slots may indicate the first control information of the first PRS. The 1^{st} slot and/or subsequent slots in the P slots may be used for transmission of the first PRS. P is an integer greater than 0.

The 1^{st} slot and the subsequent slots in the P slots may be consecutive, or may be non-consecutive. Optionally, the second resource of the first control information may be located in a slot n, and the first resource of the first PRS may be located in a slot range [n+T, n+T+P−1], where T may be an integer greater than or equal to 0. T may represent a minimum gap between the second resource and the first resource, that is, a gap between the 1^{st} slot and the subsequent slots in every P slots. A value of T may be defined in a standard. For example, T may be configured or pre-configured by a network device. The terminal device may determine, based on a minimum value of T, whether to receive the first PRS based on the detected first control information. It may be understood that, when T=0, the 1^{st} slot and the subsequent slots in the P slots are consecutive, so that a positioning delay can be reduced.

It may be understood that the second resource is not later than the first resource. In this way, after receiving the first control information corresponding to the first PRS, the terminal device that receives the first PRS may determine, based on an indication of the first control information, whether to receive the first PRS or how to receive the first PRS (for example, in a time frequency resource position).

The second resource pool may include a first slot, the first slot may be distinguished on a frequency domain resource, and different frequency domain resources are separately used for transmission of a PRS and control information that indicates the PRS. To be specific, the first slot may include a resource (referred to as a PRS resource for short) used for transmission of a PRS and a resource (referred to as a control information resource for short) used for transmission of control information that indicates the PRS. The PRS resource and the control information resource may be located in different frequency domain positions. In other words, the first slot in the second resource pool may indicate the PRS and also indicate the control information. For example, the 1^{st} slot in every P slots may be the first slot. It should be noted that the resource used for transmission of the PRS may also be referred to as a PRS resource or a PRS transmit resource. The PRS resource may be a minimum granularity of a resource occupied by the terminal device to send the PRS. The resource used for transmission of the control information that indicates the PRS may be referred to as a control information resource. The control information resource may be a minimum granularity of a resource occupied by the terminal device to send the control information used for indicating the PRS. In a case in which the control information is carried on a PSCCH, the control information resource may be referred to as a PSCCH resource.

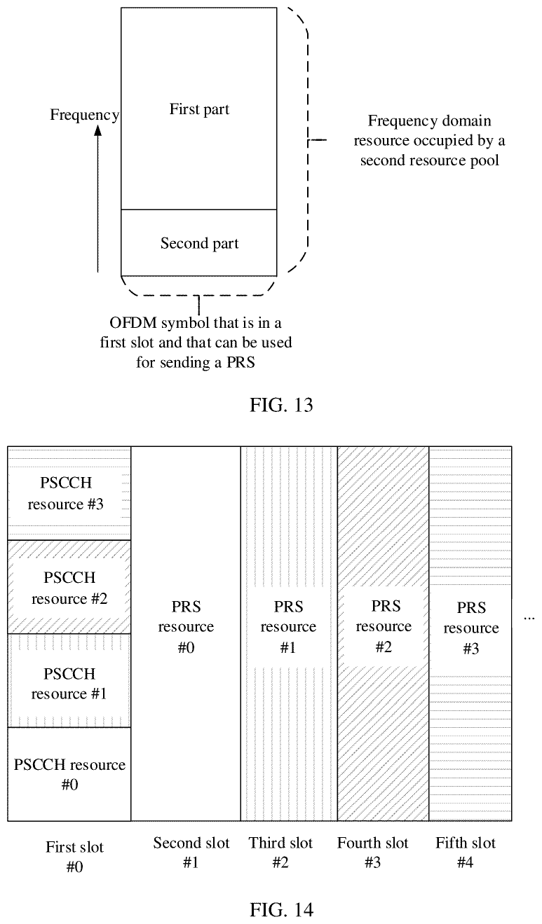

FIG. 13 is a schematic diagram of a division manner of a first slot according to an embodiment of this application. As shown in FIG. 13, the first slot may include a first part and/or a second part in a frequency domain range. The first part may be used for transmission of one or more PRSs, and the second part may be used for transmission of one or more pieces of control information used for indicating the PRS. Both the first part and/or the second part may be located in an OFDM symbol used for sending a PRS. For example, the first part may be used for transmission of the first PRS. The second part may be used for transmission of the first control information. Alternatively, the terminal device may further transmit or receive a second PRS and second control information, and the second control information may indicate the second PRS. The first part may be used for transmission of the first PRS and/or the second PRS. The second part may be used for transmission of the first control information and/or the second control information.

Optionally, a PRB occupied by the second part may be lower than a PRB occupied by the first part. For example, N PRBs in the lowest position in one slot may be the second part, and remaining PRBs may be the first part. A receive end may start to receive a PRB from a low position. Based on this slot structure, the receive end may receive the first control information before receiving the first PRS, so that the receive end may receive the first PRS based on information indicated by the first control information.

It may be understood that, if the first slot is configured with the resource used for transmission of the control information that indicates the PRS, the first slot may not be configured with the resource used for transmission of the PRS. For example, the first slot may be configured with a transmission resource of the first control information and/or a transmission resource of the second control information, and the first slot may not be configured with a transmission resource of the first PRS and a transmission resource of the second PRS. In an implementation, the 1^{st} slot in every P slots may be the first slot. When P is greater than 1, the first slot may not be configured with resources used for transmission of PRS(s) (including the first PRS and the second PRS).

Optionally, a plurality of resources used for transmission of control information may be included in a frequency domain range of the second part, and a resource used for transmission of a control signal is in a one-to-one correspondence with a resource used for transmission of a PRS. For example, the transmission resource of the second PRS may be a third resource, and the transmission resource of the second control information may be a fourth resource. The third resource may be different from the first resource used for transmission of the first PRS, and the fourth resource may be different from the second resource used for transmission of the first control information. The first resource is uniquely mapped to the second resource, and the third resource is uniquely mapped to the fourth resource.

In an implementation, M control information resources may be included in a range of frequency domain resources used for transmission of control information that indicates a PRS, and the M control information resources may constitute a resource set. The M control information resources may respectively indicate M PRSs. M may be an integer greater than 0. For example, M may be a quantity of PRS resources in a slot range [n+T, n+T+P−1]. It may be understood that each control information resource may be one-to-one mapped to a PRS resource. For example, a resource set may include M control information resources, indexes may be respectively 0, 1, 2, . . . , and M−1, and an i^{th} resource used for transmission of control information may be mapped to an i^{th} PRS resource. i may represent an index of a PRS resource or a resource used for transmission of control information, where 0≤ i≤ M−1. If the terminal device sends the first control information on the i^{th} control information resource, the terminal device also sends the first PRS on the i^{th} PRS resource.

FIG. 14 is an example diagram of M control information resources included in one slot according to an embodiment of this application. In the time frequency resources shown in FIG. 14, P=5 and M=4. A slot #0 may be a first slot of specific five slots. A control information resource may be carried by a PSCCH. The slot #0 may include four resources used for transmission of control information, and the four resources are respectively a PSCCH resource #0, a PSCCH resource #1, a PSCCH resource #2, and a PSCCH resource #3. PRS resources corresponding to the PSCCH resource #0, the PSCCH resource #1, the PSCCH resource #2, and the PSCCH resource #3 are located in the 2^{nd} slot to the 5th slot. The 2^{nd} slot to the 5th slot are respectively configured with resources used for transmission of a PRS, and the resources are respectively a PRS resource #0, a PRS resource #1, a PRS resource #2, and a PRS resource #3. The PSCCH resource #0, the PSCCH resource #1, the PSCCH resource #2, and the PSCCH resource #3 are in a one-to-one correspondence with the PRS resource #0, the PRS resource #1, the PRS resource #2, and the PRS resource #3.

It may be understood that a plurality of resources used for transmission of a PRS may be included in a same slot. Indexes of the plurality of PRS resources may be consecutive. That is, a plurality of physical resources used for transmission of a PRS are consecutive. The terminal device may transmit or receive, on resources that correspond to a plurality of PRSs and that are used for transmission of control information that indicates a PRS, the control information that indicates the PRS. The terminal device may send control information on one resource, and indicate, by using a specific information field on the resource, a plurality of occupied PRS resources. This may reduce a peak-to-average power ratio (PAPR).

### Embodiment 2.2

Both the first resource and the second resource belong to the second resource pool. The first resource and the second resource may occupy a same time domain resource. For example, both the first resource and the second resource may belong to a second slot. The first resource and the second resource may respectively occupy different frequency domain resources of the second slot. An OFDM symbol occupied by the first resource may be different from an OFDM symbol occupied by the second resource. In some embodiments, the same time domain resource occupied by the first resource and the second resource may be referred to as a PRS and control resource. The PRS and control resource may include a plurality of parts. The plurality of parts may include a first part and a second part. The first part may be used for transmission of control information that indicates a PRS, and the second part may be used for transmission of the PRS.

It may be understood that there may be one or more OFDM symbols occupied by the first resource, and there may be one or more OFDM symbols occupied by the second resource. The OFDM symbol occupied by the first resource may be partially different from the OFDM symbol occupied by the second resource. For example, the OFDM symbol occupied by the first resource may include a symbol #1, and the OFDM symbol occupied by the second resource may include the symbol #1, a symbol #2, and a symbol #3. Alternatively, the OFDM symbol occupied by the first resource may be completely different from the OFDM symbol occupied by the second resource. For example, the OFDM symbol occupied by the first resource may include a symbol #1, and the OFDM symbol occupied by the second resource may include a symbol #2, a symbol #3, and a symbol 4 #.

One PRS and control resource may include at least three OFDM symbols. The 1^{st} OFDM symbol may be used for AGC adjustment. Some or all resources in the 2^{nd} OFDM symbol may be used for transmission of control information that indicates a PRS. Some resources in the 2^{nd} OFDM symbol and resources after the 2^{nd} OFDM symbol may be used for transmission of the PRS. For example, the second resource may occupy some or all resources in the 2^{nd} symbol. The first resource may occupy resources after the 2^{nd} symbol. In a case in which the second resource occupies some resources in the 2^{nd} symbol, the first resource may also occupy some resources in the 2^{nd} symbol.

In a case in which in one symbol, some resources are used for transmission of the first PRS and some resources are used for transmission of the first control information, the first control information may occupy some resources of the symbol that starts from the 1^{st} PRB, and remaining some resources may be used for transmission of the first PRS. In other words, the transmit end terminal device may map, starting from the 1^{st} PRB, in a manner of frequency domain first and then time domain, a modulation symbol of a PSCCH that carries the first control information. Then, the first PRS may be sent on the remaining resources.

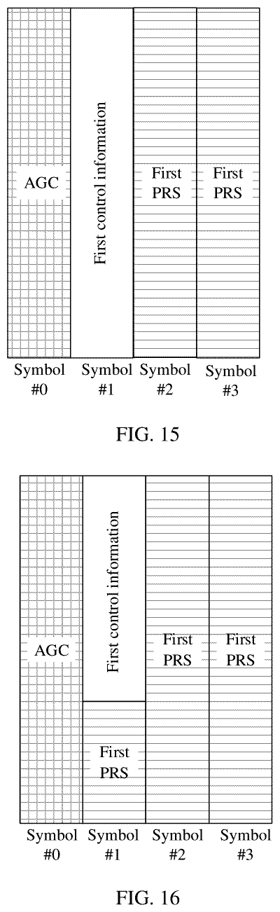

With reference to the embodiments shown in FIG. 15 and FIG. 16, the following exemplifies a case of the OFDM symbol occupied by the first resource and the OFDM symbol occupied by the second resource.

FIG. 15 is an example diagram of a resource division manner according to an embodiment of this application. In the slot, one PRS and control resource may occupy four OFDM symbols. A symbol #0 may be used for AGC. A symbol #1 may be used for transmission of the first control information, and a symbol #2 and a symbol #3 may be used for transmission of the first PRS.

FIG. 16 is an example diagram of another resource division according to an embodiment of this application. In the slot, the first resource and the second resource may occupy four OFDM symbols. A symbol #0 may be used for AGC. Some PRBs in a symbol #1 may be used for transmission of the first control information, and remaining PRBs in the symbol #1 may be used for transmission of the first PRS. A symbol #2 and a symbol #3 may be used for transmission of the first PRS. In this case, a DMRS of the PSCCH that carries the first control information may be used for calculating positioning information.

It may be understood that one or more PRS and control resources may be included in the second slot. For example, a resource used for transmission of the second PRS and a resource used for transmission of the second control information may further be included in the second slot.

### Embodiment 3: The First Resource Belongs to the Second Resource Pool, and the Second Resource Belongs to the First Resource Pool

In an implementation, the first resource used for transmission of the first PRS may belong to the second resource pool. The second resource used for transmission of the first control information may belong to the first resource pool.

The first control information may be indicated by a PSSCH/PSCCH sent in the first resource pool used for sidelink communication. The first resource pool used for sidelink communication may be associated with one or more resource pools used for transmission of a PRS. The PSCCH/PSSCH sent in the first resource pool may explicitly and/or implicitly indicate transmission of the PRS in one resource pool that is associated with the first resource pool and that is used for transmission of the PRS.

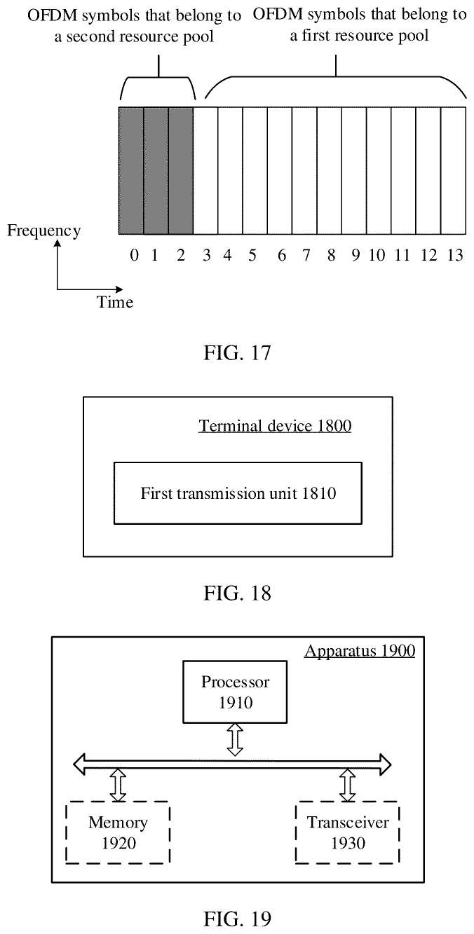

In an implementation, the first resource pool and the second resource pool may include a same slot. In one slot, first H OFDM symbols may belong to the second resource pool, and remaining OFDM symbols may belong to the first resource pool. H may be an integer greater than 0. FIG. 17 is a schematic diagram of a structure of a slot according to an embodiment of this application. The slot shown in FIG. 17 may include 14 OFDM symbols. First 3 OFDM symbols (symbols 0, 1, and 2) may belong to the second resource pool, to transmit a PRS. Last 11 OFDM symbols (symbols 3 to 13) may belong to the first resource pool, to perform sidelink communication and indicate the PRS.

It may be understood that the first resource and the second resource may be located in different slots. For example, the first resource may be located in a slot m, and the second resource may be located in a slot n, where m and n may be integers greater than 0. There may be a gap between the slot m and the slot n. The gap may be indicated by information carried in a PSCCH/PSSCH. Alternatively, the gap may be not less than a specific value, and the specific value may be, for example, a number of the 1^{st} slot that belongs to the second resource pool.

Optionally, the first PRS may be sent in a specific periodicity, or may be sent for a plurality of times in each periodicity. A sending periodicity of the first PRS and/or a quantity of sending times in each periodicity may be indicated by the information carried in the PSCCH/PSSCH. For example, the sending periodicity of the first PRS may be directly or indirectly determined by a sending periodicity of the PSSCH indicated in the PSCCH. In an implementation, the sending periodicity of the first PRS may be the same as the sending periodicity of the PSSCH indicated in the PSCCH. For example, the quantity of sending times of the first PRS in each periodicity may be directly or indirectly determined by a quantity of repetition times of the PSSCH indicated in the PSCCH.

The foregoing describes method embodiments of this application in detail with reference to FIG. 1 to FIG. 17. The following describes apparatus embodiments of this application in detail with reference to FIG. 18 and FIG. 19. It should be understood that the description of the method embodiments corresponds to the description of the apparatus embodiments, and therefore, for parts that are not described in detail, reference may be made to the foregoing method embodiments.

FIG. 18 is a schematic diagram of a structure of a terminal device 1800 according to an embodiment of this application. The terminal device 1800 may include a first transmission unit 1810.

The first transmission unit 1810 may be configured to transmit or receive a first positioning reference signal PRS and first control information on a sidelink, where the first control information indicates the first PRS.

Optionally, a transmission resource of the first PRS is a first resource, a transmission resource of the first control information is a second resource, both the first resource and the second resource belong to a first resource pool, and the first resource pool is used for sidelink communication.

Optionally, the first resource pool includes a third resource, the third resource includes a resource occupied by a physical sidelink shared channel PSSCH and/or a resource occupied by a demodulation reference signal DMRS of the PSSCH, and the first resource is located in a range of the third resource.

Optionally, the first resource pool includes a fourth resource, the fourth resource includes a resource occupied by a physical sidelink feedback channel PSFCH, and the first resource is located on a symbol in which the fourth resource is located.

Optionally, the first control information is included in first-order sidelink control information SCI and/or second-order SCI.

Optionally, the first resource pool includes a resource occupied by a physical sidelink control channel PSCCH that schedules a PSSCH, and an identity of the first PRS is determined by a cyclic redundancy check CRC of the PSCCH that schedules the PSSCH.

Optionally, a transmission resource of the first PRS is a first resource, the first resource belongs to a second resource pool, and the second resource pool and a first resource pool that is used for sidelink communication are configured by using different signalling.

Optionally, a transmission resource of the first control information is a second resource, and the second resource belongs to the second resource pool.

Optionally, the second resource is not later than the first resource.

Optionally, the terminal device may further include a second transmission unit.

The second transmission unit is configured to transmit or receive a second PRS and second control information. The second PRS is indicated based on the second control information, the second resource pool includes a first slot, the first slot includes a first part and/or a second part in a frequency domain range, the first part is used for transmission of the first PRS and/or the second PRS, and the second part is used for transmission of the first control information and/or the second control information.

Optionally, a physical resource block PRB occupied by the second part is lower than a PRB occupied by the first part.

Optionally, the second resource pool includes a second slot, both the first resource and the second resource belong to the second slot, and an OFDM symbol occupied by the first resource is different from an OFDM symbol occupied by the second resource.

Optionally, a transmission resource of the first control information is a second resource, and the second resource belongs to the first resource pool.

Optionally, the first resource pool includes a resource occupied by a PSCCH that schedules a PSSCH, the first control information includes a quantity of repetition times of the first PRS, and the quantity of repetition times of the first PRS is determined by a quantity of repetition times of the PSSCH indicated in the PSCCH.

Optionally, the first resource pool includes the resource occupied by the PSCCH that schedules the PSSCH, the first control information includes a sending periodicity of the first PRS, and the sending periodicity of the first PRS is determined by a sending periodicity of the PSSCH indicated in the PSCCH.

Optionally, the first control information includes one or more pieces of the following information: an identity of the first PRS, a position of a resource occupied by the first PRS, a quantity of repetition times of the first PRS, a sending periodicity of the first PRS, and information about a terminal device that sends the first PRS.

Optionally, the terminal device may further include a first determining unit. The first determining unit may be configured to determine a global positioning coordinate of the terminal device based on the first PRS.

Optionally, the terminal device performs sidelink communication with a first device, and the terminal device may further include a second determining unit. The second determining unit may be configured to determine a distance and/or a direction of the terminal device relative to the first device based on the first PRS.

FIG. 19 is a schematic diagram of a structure of a communications apparatus according to an embodiment of this application. The dashed lines in FIG. 19 indicate that the unit or module is optional. The apparatus 1900 may be configured to implement the method described in the foregoing method embodiments. The apparatus 1900 may be a chip, a terminal device, or a network device.

The apparatus 1900 may include one or more processors 1910. The processor 1910 may allow the apparatus 1900 to implement the method described in the foregoing method embodiments. The processor 1910 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1900 may further include one or more memories 1920. The memory 1920 stores a program that may be executed by the processor 1910 to cause the processor 1910 to perform the methods described in the foregoing method embodiments. The memory 1920 may be independent of the processor 1910 or may be integrated into the processor 1910.

The apparatus 1900 may further include a transceiver 1930. The processor 1910 may communicate with another device or chip through the transceiver 1930. For example, the processor 1910 may send and receive data to and from another device or chip through the transceiver 1930.

An embodiment of this application further provides a computer-readable storage medium for storing a program. The computer-readable storage medium may be applied to the terminal or the network device provided in the embodiments of this application, and the program causes a computer to execute the methods performed by the terminal or the network device in various embodiments of this application.

An embodiment of this application further provides a computer program product. The computer program product includes a program. The computer program product may be applied to the terminal or the network device provided in embodiments of this application, and the program causes a computer to execute the methods performed by the terminal or the network device in various embodiments of this application.

An embodiment of this application further provides a computer program. The computer program may be applied to the terminal or the network device provided in embodiments of this application, and the computer program causes a computer to execute the methods performed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, the “indication” mentioned may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In embodiments of this application, “B that is corresponding to A” means that B is associated with A, and B may be determined based on A. However, it should also be understood that, determining B based on A does not mean determining B based only on A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” and “pre-configuration” can be implemented by pre-storing a corresponding code or table in a device (for example, including the terminal device and the network device) or in other manners that can be used for indicating related information, and a specific implementation thereof is not limited in this application. For example, pre-defining may refer to being defined in a protocol.

In embodiments of this application, the “protocol” may refer to a standard protocol in the communication field, which may include, for example, an LTE protocol, an NR protocol, and a related protocol applied to a future communications system, and this application is not limited in this regard.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communications connections may be implemented by using some interfaces. The indirect couplings or communications connections between apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objective of the solutions of the embodiments.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
transmitting or receiving, by a terminal device, a first positioning reference signal (PRS) and first control information on a sidelink, wherein the first control information indicates the first PRS.

2. The method according to claim 1, wherein a transmission resource of the first PRS is a first resource, a transmission resource of the first control information is a second resource, both the first resource and the second resource belong to a first resource pool, and the first resource pool is used for sidelink communication.

3. The method according to claim 2, wherein the first resource pool comprises a third resource, the third resource comprises a resource occupied by a physical sidelink shared channel (PSSCH), and the first resource is located in a range of the third resource.

4. The method according to claim 2, wherein the first control information is comprised in second-order sidelink control information (SCI).

5. The method according to claim 2, wherein the first resource pool comprises a resource occupied by a physical sidelink control channel PSCCH that schedules a PSSCH, and an identity of the first PRS is determined by a cyclic redundancy check (CRC) of the PSCCH that schedules the PSSCH.

6. The method according to claim 1, wherein a transmission resource of the first PRS is a first resource, the first resource belongs to a second resource pool, and the second resource pool and a first resource pool that is used for sidelink communication are configured by using different signalling.

7. The method according to claim 6, wherein a transmission resource of the first control information is a second resource, and the second resource belongs to the second resource pool.

8. The method according to claim 7, wherein the second resource is not later than the first resource.

9. The method according to claim 7, wherein the second resource pool comprises a second slot, both the first resource and the second resource belong to the second slot, and an orthogonal frequency division multiplexing (OFDM) symbol occupied by the first resource is different from an OFDM symbol occupied by the second resource.

10. The method according to claim 1, wherein the first control information comprises one or more pieces of the following information: an identity of the first PRS, a position of a resource occupied by the first PRS, a quantity of repetition times of the first PRS, a sending periodicity of the first PRS, and information about a terminal device that sends the first PRS.

11. The method according to of claim 1, wherein the method further comprises:
determining, by the terminal device, a global positioning coordinate of the terminal device based on the first PRS.

12. The method according to claim 1, wherein the terminal device performs sidelink communication with a first device, and the method further comprises:
determining, by the terminal device, a distance and/or a direction of the terminal device relative to the first device based on the first PRS.

13. A terminal device, comprising a memory and a processor, wherein the memory is configured to store a program, and the processor is configured to invoke the program in the memory to execute a method comprising:
transmitting or receiving a first positioning reference signal (PRS) and first control information on a sidelink, wherein the first control information indicates the first PRS.

14. The terminal device according to claim 13, wherein a transmission resource of the first PRS is a first resource, a transmission resource of the first control information is a second resource, both the first resource and the second resource belong to a first resource pool, and the first resource pool is used for sidelink communication.

15. The terminal device according to claim 14, wherein the first resource pool comprises a third resource, the third resource comprises a resource occupied by a physical sidelink shared channel (PSSCH), and the first resource is located in a range of the third resource.

16. The terminal device according to claim 14, wherein the first control information is comprised in second-order sidelink control information (SCI).

17. The terminal device according to claim 14, wherein the first resource pool comprises a resource occupied by a physical sidelink control channel (PSCCH) that schedules a PSSCH, and an identity of the first PRS is determined by a cyclic redundancy check (CRC) of the PSCCH that schedules the PSSCH.

18. The terminal device according to claim 13, wherein a transmission resource of the first PRS is a first resource, the first resource belongs to a second resource pool, and the second resource pool and a first resource pool that is used for sidelink communication are configured by using different signalling.

19. The terminal device according to claim 18, wherein a transmission resource of the first control information is a second resource, and the second resource belongs to the second resource pool.

20. The terminal device according to claim 19, wherein the second resource is not later than the first resource.
